(19) United States
(12) Patent Application Publication
(10) Pub. No.: US 2009/0258813 A1
(43) Pub. Date: Oct. 15, 2009

(54) Clean freeze

(76) Inventors: Juanita C. Blount, Pensacola, FL (US); Stephen M. Guttmann, Pensacola, FL (US)

Correspondence Address: STEPHEN M. GUTTMANN, #203, 314 S. BAYLEN ST, PENSACOLA, FL, 32502, US

(21) Appl. No.: 12/082,821

(22) Filed: Apr. 15, 2008

(51) Int. Cl. C11D 3/10

(52) U.S. Cl. 510/509

(57) ABSTRACT

This invention is the freezing of a baking soda/water/lemon juice/orange juice mixture, as a cleaning material. The freezing of cleaning agents to improve the cleaning process. The placement of the mixture into a tear-away paper container.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This cleaner is ideal for the cleaning of glass and other similar materials that are prone to scratching. In particular, there does not appear to be a cleaner that is effective in cleaning smooth-top stoves. This cleaner is effective in cleaning dishes, pots, pans, and all parts of bathrooms and many other similar items.

### BRIEF SUMMARY OF THE INVENTION

Baking soda is a well-known and widely used substance for effective cleaning, especially on substances that are prone to scratching. One of the problems in using baking soda in cleaning is it becomes powdery or watery if mixed with water, and the cleaning capability of the soda becomes compromised. When baking soda is mixed with lemon juice, orange juice, or water to an approximate consistency of toothpaste, and then frozen, the block of frozen soda becomes an effective substance for cleaning.

### BRIEF DESCRIPTION OF THE SEVERAL VIEWS OF THE DRAWING

N/A

### DETAILED DESCRIPTION OF THE INVENTION

Take one cup of baking soda and mix it with seven Tablespoons of lemon juice, orange juice, or water. Mix. Take the mixture and put it into a paper container and freeze. You may add a fragrance, such as orange, strawberry, lemon, or others. After the mixture is frozen, tear away a portion of the paper and rub the mixture onto the material that needs to be cleaned until it is sufficiently clean. Wipe away the residue with a damp rag or paper towel.

1. The mixing of water and baking soda and freezing same as a cleaning agent.

2. The mixing of lemon juice and baking soda and freezing same as a cleaning agent.

3. The mixing of orange juice and baking soda and freezing same as a cleaning agent.
